(19) United States
(12) Patent Application Publication
(10) Pub. No.: US 2023/0118781 A1
(43) Pub. Date: Apr. 20, 2023

(54) ABSORPTIVE REUSABLE COASTER

(71) Applicant: Studio Eight LLC, San Jose, CA (US)

(72) Inventor: Tung-Po Yang, San Jose, CA (US)

(73) Assignee: Studio Eight LLC, San Jose, CA (US)

(21) Appl. No.: 17/451,083

(22) Filed: Oct. 15, 2021

(51) Int. Cl. A47G 23/032; A47G 23/03; B32B 7/14; B32B 29/02

(52) U.S. Cl. CPC A47G 23/032; A47G 23/0306; B32B 7/14; B32B 29/02; B32B 2250/02; B32B 2307/726; B32B 2307/4023; B32B 2571/00; B32B 2262/14; B32B 2262/062; B32B 2262/0276

(57) ABSTRACT

Reusable coasters with absorptive properties and liquid-activated designs are described herein. In some embodiments, the coaster includes a cover layer with bonded fibers and a liquid absorption layer. An adhesive may bond the first layer and second layer around a perimeter such that a portion is not bonded to prevent the adhesive from obstructing liquid passing from the bonded fibers of the first layer to the absorptive material included in the second layer. The opening in the portion may further prevent obstructing the view of liquid-activated images, which may be printed on the liquid absorption layer. The cover layer may protect the liquid absorption layer from direct contact with solid objects and help maintain the shape of the absorptive material when wet.

### TECHNICAL FIELD

The present disclosure relates generally to coasters and, more specifically, reusable coasters with absorptive properties and liquid-activated designs.

### BACKGROUND

A coaster is an article of manufacture designed to protect a surface from drinkware and other liquid containers. The container may be placed upon a coaster rather than directly on the surface to prevent damage caused by condensation and spills. A coaster may further protect the surface from scratches as the container is placed, lifted, or otherwise moved.

Coasters may be reusable or disposable depending on the material of manufacture. Reusable coasters are generally constructed from durable non-absorptive material such as glass, metal, plastic, or treated wood. Disposable coasters are generally constructed from less durable but more absorptive material, such as paper, which is cheaper to manufacture and may provide added protection from spills. However, disposable coasters typically warp when liquid is absorbed, requiring frequent replacement and associated costs. The design of a disposable coaster may also become distorted and unattractive as the material warps.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates an exploded, perspective view of a multilayer coaster in accordance with some embodiments;

FIG. 1B illustrates another exploded, perspective view of a multilayer coaster with an additional layer in accordance with some embodiments;

FIG. 2 illustrates an example set of operations for applying inks to varying coaster layers in accordance with some embodiments;

FIG. 3 illustrates two top views of a coaster demonstrating a hidden message that is activated by liquid in accordance with some embodiments; and

FIG. 4 illustrates two top views of a coaster demonstrating a hidden message and artwork that is activated by liquid in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. COASTER LAYERS AND STRUCTURES

3. INK APPLICATION TECHNIQUES FOR DIFFERENT COASTER LAYERS

4. EXAMPLE LIQUID-ACTIVATED COASTER DESIGNS

5. MISCELLANEOUS; EXTENSIONS

1. General Overview

Embodiments described herein include a reusable coaster with absorptive properties. In some embodiments, the coaster comprises a plurality of layers including a liquid absorption layer and a cover layer. The liquid absorption layer may include highly absorptive material, such as water-soluble paper, that retains large amounts of liquid relative to the layer and coaster size. The cover layer may include bonded fibers to protect the absorptive material from liquid containers and other solid objects placed on the multi-layer coaster. The cover layer may further provide structural support to the liquid absorption layer to reduce or prevent warping of the shape of the liquid absorption layer and coaster when wet.

In some embodiments, the multi-layered coaster includes an adhesive layer that bonds the cover layer and the liquid absorption layer around a perimeter. The adhesive layer may include an opening within the perimeter adhesive such that a center portion of the cover layer and the liquid absorptive layer are not bonded, thereby preventing the adhesive layer from obstructing liquid passing from the bonded fibers to the absorptive material. The omission of adhesive within the center portion between the cover layer and liquid absorptive layer further allows for a more evenly distributed spread of liquid by the bonded fibers to the absorptive material. A perimeter bond prevents the layers from separating and provides structural support between the layers to help minimize warping while retaining liquid.

In some embodiments, one or more layers of the coaster include color-changing ink that changes color when wet. A printing process may apply wet ink for color changing over ink that does not change color. The ink that does not change color may include UV curing ink, which dries quickly after application, preventing smearing and allowing liquid-activated designs to stay sharp.

In some embodiments, the multi-layered coaster may include other layers, such as an insulation layer to reduce the heat transfer between the solid object placed on the coaster and the surface where the coaster rests. Each coaster layer, individually and/or in combination with other layers, may provide the coaster with additional characteristics and functionality as described further herein.

In some embodiments, individual layers described herein may also be implemented as a single-layer coaster. In other embodiments, multiple layers may be combined into a single layer. For example, a single-layer coaster may include UV ink and color changing ink such that an aesthetic component and/or message on the coaster changes when wet.

One or more embodiments described in this Specification and/or recited in the claims may not be included in this General Overview section.

2. Coaster Layers and Structures

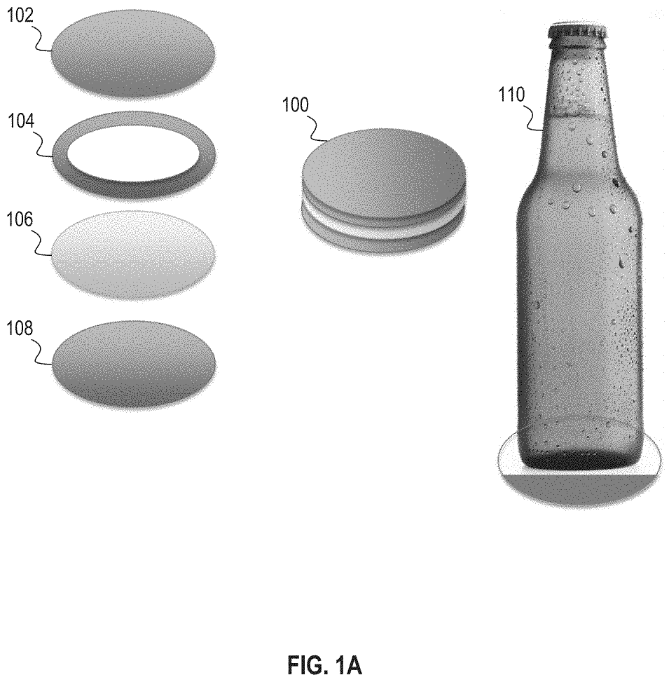

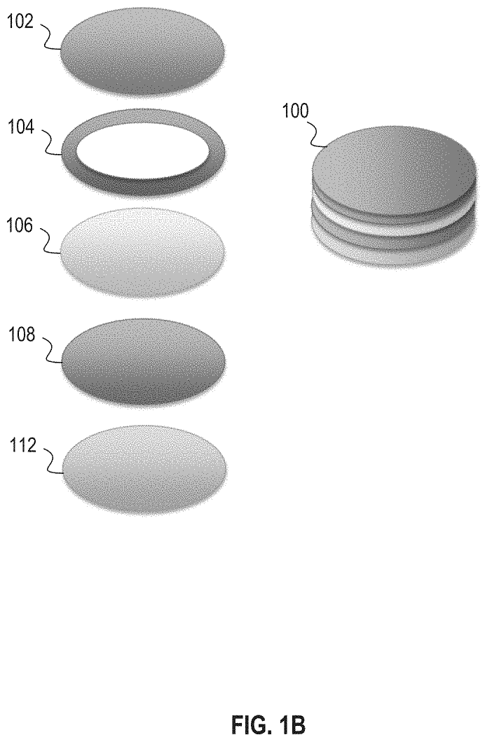

FIG. 1A illustrates an exploded, perspective view of multilayer coaster 100 in accordance with some embodiments. As illustrated, coaster 100 includes cover layer 102, adhesive layer 104, liquid absorption layer 106, and insulation layer 108. Coaster 100 may include additional layers and/or may omit one or more of the illustrated layers, depending on the particular implementation. Additionally or alternatively, one or more layers, or portions thereof, may be integrated into a single layer.

In some embodiments, cover layer 102 is the topmost layer of coaster 100. Cover layer 102 may have a weave construction formed from fibrous material. For example, the woven fabric may include a polyester blend of fibers, such as 50% polyester and 50% paper, to provide structural strength and absorptive properties. However, the percentages in the blend and the woven materials may vary depending on the particular implementation. A greater ratio of polyester may increase rigidity but reduce the absorptive capacity of the layer. A balance point may be selected accordingly. Other polymers and fibrous substances, including cotton fibers, may be included in the blend in addition or as an alternative to the polyester and/or paper fibers.

In some embodiments, a hydroentanglement process, sometimes referred to as spunlacing, is used to bond a blend of fibers in cover layer 102. The spunlacing process may use high pressure water streams to split and entangle the fibers to form a bond. The spunlacing process may be performed in a clean room to prevent contaminants from compromising the bond strength. The resulting spun-lace fabric may be referred to as nonwoven fabric since the bond between fibers is formed through hydroentanglement, which differs from bonds formed through traditional weaving or knitting. However, the spunlacing process may entangle the fibers in cover layer 102 with a patterned weave. A weave construction for the spun-lace fabric may provide a porous layer to allow excess liquid to pass through to lower layers. The pores of the weave construction may further serve to spread the excess liquid, allowing for a more even distribution of the liquid to the lower layers of coaster 100. The spun-lace polyester and paper fibers is also semi-transparent in color and becomes more transparent when wet, allowing for artwork and other design elements printed on lower layers of the coaster to be seen without significantly obstructing the view.

In some embodiments, cover layer 102 is constructed from microfibers and/or nanofibers. As previously mentioned, the spunlacing process may split fibers before hydroentanglement. The spunlacing process provides a fabric with a relatively strong and resilient structure. As a result, cover layer 102 may remain rigid and retain its shape when wet with little or no warping. Additionally, the fabric is scratch free to electronic devices and beverage containers that may be placed on coaster 100.

Cover layer 102 may include a design component, including artwork, aesthetic designs, and/or messaging. The weave structure of cover layer 102 may present challenges to applying the design component as the inter-fiber pores may increase the likelihood that ink is smeared to lower layers in coaster 100. Techniques for applying ink are described below in Section 3, titled “Ink Application Techniques for Different Coaster Layers.”

In some embodiments, adhesive layer 104 bonds cover layer 102 and liquid absorption layer 106. Adhesive layer 104 may comprise double-sided tape with an acrylic polymer adhesive, which maintains adhesion strength at boiling temperature, when wet, or both. Thus, the bond between cover layer 102 and liquid absorption layer 106 is maintained even when liquid of varying temperatures is spilled, which may enhance the reusability of coaster 100. Additionally or alternatively, other types of adhesive material may be used to bond the layers together including urethane and other fabric adhesives.

In some embodiments, adhesive layer 104 includes an opening in a center portion of the layer. The double-sided tape or other adhesive material may circumscribe the opening creating a perimeter bond between cover layer 102 and liquid absorption layer 106. In an example implementation, the adhesive around the perimeter may be approximately 20 millimeters (mm) in width with an outside diameter of 88.8 mm. However, the width of the bonding material around the perimeter and/or outside diameter may vary depending on the particular implementation.

Additionally or alternatively, the shape of the perimeter adhesive may vary from implementation to implementation. In the illustrated example, the coaster layers and perimeter adhesive are circular, resulting in a circular hole in the center portion of adhesive layer 104. However, the layers and/or adhesive layer may have other shapes, such as a polygonal or ovoid shape. For example, the layers of coaster 100 may have square shapes. In this example, adhesive layer 104 may include double sided tape that circumscribes the perimeter of the square, resulting in a square opening in the center portion of the layer. In other embodiments, the shape of the perimeter and/or opening may vary. The opening in the center prevents the double-sided tape and/or other adhesive material from obstructing liquid passing from the bonded fibers of cover layer 102 to the absorptive material included in liquid absorption layer 106. Thus, excess liquid not absorbed by cover layer 102 may spread and pass through easily to liquid absorption layer 106. The smaller fibers may further increase transparency of cover layer 102 when wet. In other embodiments, the portion of the layers that are not adhered may be off-center. For example, the direct center may include a small amount of adhesive to adhere cover layer and liquid absorption layer 106, and the opening may form a ring around the center to allow liquid to pass from one layer to the next.

In some embodiments, liquid absorption layer 106 includes highly absorptive material to retain excess liquid that was not absorbed by cover layer 102. An example absorptive material is water-soluble paper, which retains a significant volume of liquid relative to its size and does not leave residue when wet. Water soluble paper may be more highly absorptive than the spun-lace fabric constructed from hydroentangled polyester and paper fibers but may be more prone to warping when wet. The resilient structure of cover layer 102 and strong adhesive bond provided by adhesive layer 104 may help reduce or prevent warping in liquid absorption layer 106, allowing the layer to maintain the same shape when dry or wet while significantly increasing the overall absorption capacity of coaster 100. The resilient structure of cover layer 102 may further protect the water-soluble paper and/or other absorptive material, which may be much more delicate, from direct contact with objects placed on coaster 100.

In some embodiments, liquid absorption layer 106 includes a liquid-activated design component that changes when wet. A design component may include artwork, patterns, text, photographs, and/or other images. All or a portion of the design component may be invisible when dry. When absorption layer 106 becomes wet, these components may become visible. For example, a hidden message may suddenly become visible when the water-soluble paper is exposed to a threshold level of liquid. Additionally or alternatively, a hidden design may appear, change colors, or change patterns.

In some embodiments, insulation layer 108 is constructed from insulating material to reduce the heat transfer between the surface between a solid object placed on coaster 100 and the surface where the coaster rests. An example insulating material is polypropylene (PP) synthetic paper. In addition to providing insulation to protect the surface from extreme temperatures, PP synthetic paper is scratch and chemical resistant, enhancing the reusability of coaster 100. PP synthetic paper is also non-liquid absorptive, retaining liquid within coaster 100 and preventing the surface under from getting wet. PP synthetic paper also provides grip to prevent sliding on the surface. Additionally or alternatively, insulation layer 108 may include other insulating material, such as cellulose and/or polyethylene, to reduce heat transfer.

In some embodiments, liquid absorption layer 106 and/or insulation layer 108 include adhesives to bond the layers together. For example, liquid absorption layer 106 may include a dissolvable acrylic adhesive A label with dissolvable acrylic adhesive may be removed without residue even when wet. Insulation layer 108 may include an acrylic adhesive that is upward facing. The adhesive material may be distributed over the entire surface area of the layers to provide a strong bond and to help retain excess liquid within coaster 100. In other cases, the adhesive may be applied to only a portion of the layers, such as around a perimeter. The opening, if any, may be smaller than adhesion layer 104 to minimize pass through of liquid. Additionally or alternatively, coaster 100 may include a separate adhesive layer that bonds liquid absorption layer 106 and insulation layer 108. The additional adhesive layer (not illustrated) may include double-sided tape and/or other bonding material to hold the layers together with little or no center opening.

Perspective view 110 illustrates an example bottle resting on the coaster in accordance with some embodiments. The bottle rests on cover layer 102 without making contact with the lower layers of coaster 100. As droplets form and run down the sides of the bottle, the liquid is absorbed by cover layer 102. Excess liquid is spread by the cover layer 102 and passes through the center portion of adhesive layer 104 to liquid absorption layer 106, which includes highly absorptive material to retain the excess liquid. Responsive to becoming wet, cover layer 102 may become transparent, and liquid-activated designs on liquid absorption layer 104 may increase in visibility, changing the aesthetic and/or messaging of coaster 100.

As previously indicated, the multilayered configuration of coaster 100 may vary depending on the particular implementation. FIG. 1B illustrates another exploded, perspective view of multilayer coaster 100 with an additional layer in accordance with some embodiments. Coaster 100 includes cover layer 102, adhesive layer 104, liquid absorption layer 106, insulation layer 108, and liner 112.

In the second configuration of coaster 100, cover layer 102, adhesive layer 104, and liquid absorption layer 106 may be the same as in the first configuration. Insulation layer 108 may have a different construction to provide more adhesion and accommodate liner 112. In some embodiments, insulation layer 108 includes polyethylene terephthalate (PET) and/or other thermoplastic polymer resin material that provide thermal insulation. The material further allows peeling for easy removal of liner 112.

In some embodiments, liner 112 is constructed from material that is easy to remove from coaster 100. For example, liner 112 may be made of paper coated in silicone that allows liner 112 to be removed cleanly. Additionally or alternatively, liner 112 may include other materials.

In some embodiments, insulation layer 108 includes a downward facing acrylic adhesive. The acrylic adhesive provides a light bond that is relatively easy to overcome when light force is applied. When liner 112 is removed, coaster 100 may be placed on a surface with insulation layer 108 forming direct contact with the surface. The downward facing acrylic adhesive may form a light bond with the surface to prevent coaster 100 from slipping or otherwise inadvertently moving. The acrylic adhesive allows the coaster to be removed without leaving residue on the surface.

In some embodiments, the adhesive strength of one or more layers of coaster 100 may be customizable. Adhesive strength may be customized by varying the coverage of the acrylic adhesive, varying the type of adhesive used, and/or varying the shape of the adhesive. For example, the downward facing acrylic adhesive of insulation layer 108 may be applied around a perimeter only or only in a center portion of the coaster. The latter adhesive shape may prevent the edges of insulation layer 108 from adhering to the surface, allowing coaster 100 to be lifted more easily. However, the adhesive strength and/or other adhesive properties may vary from implementation to implementation.

3. Ink Application Techniques for Different Coaster Layers

In some embodiments, one or more layers of coaster 100 include color-changing ink that change the coaster design in certain conditions. For example, hydrochromic inks change color when wet. Hydrochromic inks may include screen inks that become clear on contact with liquids and return to an original color, such as white, once dry. The screen inks may thus be used to obscure an underlying design when dry. Upon exposure to liquid, the obscured design becomes visible until the coaster layer dries.

Additionally or alternatively, coaster 100 may include other types of color-changing ink, such as thermochromic inks that change color based on temperature. Thermochromic inks may include screen inks that become clear when the temperature is above a threshold and return to an original color when the temperature drops below the threshold. The screen inks may thus be used to obscure an underlying design when at or below room temperature. Upon exposure to heat, such as when a hot beverage is placed on coaster 100 or hot liquid is absorbed, the obscured design becomes visible until the layer cools.

Additionally or alternatively, color-changing ink may involve other changes in the hue, tint, tone, and/or shade of a color. For example, the ink color may change from blue to green or from a dark blue to light blue. The color changes may increase the visibility or intensity of already visible images or portions thereof when wet. For instance, all or a portion of an image may turn a brighter shade of a particular hue when wet to highlight certain visual elements of a design. Additionally or alternatively, images or portions thereof that are not visible or barely visible may increase in visibility to highlight the visual elements of the design.

In some embodiments, designs are printed on different layers of coaster 100. For example, part of a design may be printed on cover layer 102 and a different part of a design may be printed on liquid absorptive layer 106, resulting in a multilayered, three-dimensional design. A combination of color-changing and non-color-changing inks may be used such that part of the design is always visible, whether the coaster is wet or dry, and another part of the design is only visible when wet and/or hot.

Non-color-changing inks may not be chemically reactive to water and/or heat in the same sense as color changing inks in some embodiments. For example, hyrdrochromic inks may chemically react, changing in chemical composition when exposed to water, to cause a color change. However, non-color-changing inks may appear darker in some instances without changing the chemical composition of the ink when water is absorbed. The inks may still be referred to as non-color-changing since a chemical reaction within the ink itself does not trigger a change in color.

In some embodiments, different ink application techniques are applied to the different coaster layers to account for different structural and/or functional characteristics of the varying coaster layers. The ink application techniques may further facilitate manufacturing and customization of coaster designs. For example, the techniques may allow for custom images to be printed on cover layer 102 when the coaster is fully assembled without the ink smearing or spreading to lower layers. Thus, coaster 100 may be mass-produced while still allowing for different designs to be applied and customized for different users at the final step.

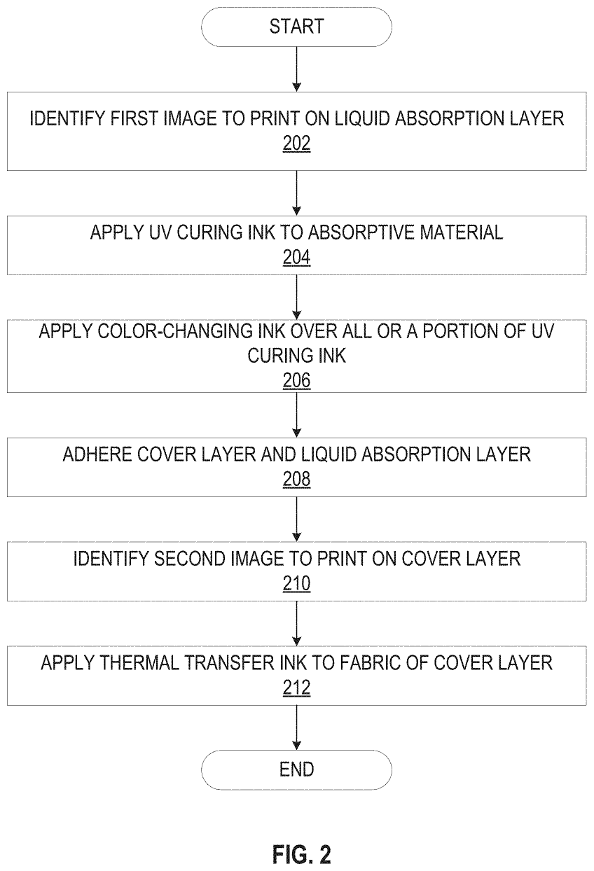

FIG. 2 illustrates an example set of operations for applying inks to a coaster, in accordance with some embodiments. One or more operations illustrated in FIG. 2 may be modified, rearranged, or omitted. Accordingly, the particular sequence of operations illustrated in FIG. 2 should not be construed as limiting the scope of one or more embodiments.

Referring to FIG. 2, the process identifies a first image to print on the liquid absorption layer (operation 202). The image may include artwork, text, patterns, photographs, and/or other visual design elements. In some embodiments, a user may submit a custom image through an online service to print on liquid absorption layer 106. For example, the user may upload an image file to a server using a client application, such as a browser. In response, the sever may store the image file in volatile or non-volatile storage. One or more print processes may access the image file, which may rasterize and/or vectorize the image for printing. Additionally or alternatively, the online service may allow a user to select from a limited set of images that are made available through the service. Restricting the set of design patterns available for liquid absorption layer 106 allows the coasters to be pre-assembled, which may significantly decrease production time and costs. Even when pre-assembled, the user may customize the coaster design by submitting images for cover layer 102 as described further below.

In some embodiments, the process prints the first image by applying ultraviolet (UV) curing ink to the absorptive material of the liquid absorption layer (operation 204). UV curing ink helps to ensure the ink dries quickly and maintains the sharpness of artwork on absorptive material, such as water-soluble paper. During the UV curing and printing process, a balance between the volume of ink, curing time, and handling time may be tuned to produce sharp images. The printing process may include letterpress, offset, or flexographic printing with approximately a threshold amount of UV exposure. A UV exposure of two seconds was found to produce high-quality designs on the absorptive material of coaster 100. However, the printing parameters, including the UV exposure time in a UV oven and ink volume, may vary from implementation to implementation. Additionally or alternatively, other forms of non-color-changing inks may be applied during the printing process.

In some embodiments, the process applies color-changing ink over the UV curing ink (operation 206). The color-changing ink may overlap all or a portion of the UV curing ink to screen all or part of the image printed on liquid absorption layer 106. The color-changing ink may include hydrochromic ink, thermochromic ink, or some combination thereof. The color-changing ink may obscure the UV-printed design or portion thereof that the ink overlaps. For example, the color-changing ink may be white or some other default color when dry, which may match the color of the absorptive material. When activated by moisture and/or heat, the ink may become clear, thereby allowing the UV-printed design to be viewed even though covered by the color-changing ink. In some embodiments, multiple layers of color-changing ink may be applied over the UV curing ink. Additional layers may help to better obscure the image in dry or mostly dry conditions. As excess liquid is absorbed by liquid absorption layer 106, each layer of the color-changing ink becomes clear, and the underlying non-color-changing ink becomes visible. In some embodiments, the color-changing ink is a wet ink that is applied through a silkscreen process. Silkscreen printing uses a mesh sheet to apply wet ink. However, the form of printing process may vary depending on the particular implementation.

In some embodiments, the process adheres the cover layer to the liquid absorption layer (operation 208). For example, the process may apply double-sided tape as previously mentioned. Additionally or alternatively, other coaster layers may be adhered at this stage, such as insulation layer 108 and liner 112.

In some embodiments, the process identifies a second image to print on the cover layer (operation 210). As previously noted, a user may submit a custom image through an online service to print on cover layer 102. A custom image may be submitted after the layers have been assembled and adhered together, which may facilitate manufacturing and inventory management operations. Custom images may be applied at the final step without significantly impacting cost. One challenge with this approach, however, is a risk that the ink spreads to lower layers of coaster 100, potentially covering the color-changing and/or UV cured ink. The print process may apply dry ink to prevent this scenario from occurring. The online service may also allow a user to select from a set of images that are made available through the service for cover layer 102.

In some embodiments, the process prints the second image by applying thermal transfer ink to the fabric of the cover layer (operation 212). Thermal transfer ink is a dry ink with a wax and/or resin formulation. With thermal-transfer printing, a print head may apply heat to a wax ribbon, melting the wax at appropriate locations on the cover layer fabric. The heated wax does not smear or spread like wet inks, allowing for a “dry” application, thereby preventing the ink contaminating lower layers of coaster 100. Thermal transfer ink has a temperature parameter of approximately 160 to 180 degrees Celsius, allowing for hot beverages to be placed on coaster 100 without warping the artwork.

In the examples given above, cover layer 102 included thermal transfer ink and liquid absorption layer 106 included color-changing ink overlapping UV curing ink. However, in other embodiments, the different types of inks may be applied to varying layers of the coaster. For instance, one or more printers may apply color-changing ink to cover layer 102 and UV curing ink to liquid absorption layer 106. Even though the color-changing is not printed directly on top of the UV curing ink in this scenario, the color-changing ink on cover layer 102 may still overlap and obscure all or a portion of an image printed on liquid absorption layer 106. Additionally or alternatively, thermal transfer ink may be applied to one or more other coaster layers, including liquid absorption layer 106. Each coaster layer may include zero or more of the different types of ink described herein in varying combinations.

4. Customizable Liquid-Activated Coaster Designs

The techniques described above allow for the creation of various liquid-activated coaster designs. A liquid-activated image may complement the aesthetics of coaster 100 that are visible when dry. For example, the liquid-activated design may complete or augment a message with text that is hidden when dry. Additionally or alternatively, exposure to liquid may activate hidden artwork that appears behind text or other design elements. Users may submit custom images to print on cover layer 102 and/or liquid absorption layer 106 to customize what design components are constant and what design components only appear when wet.

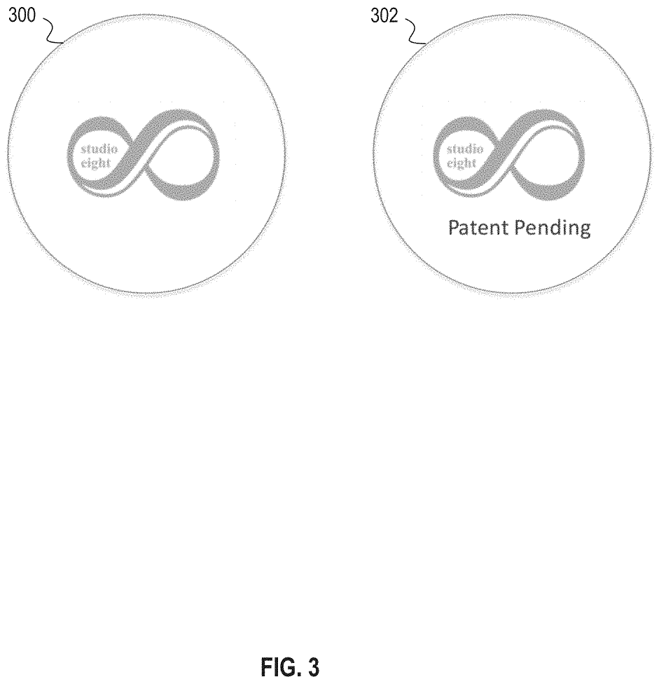

FIG. 3 illustrates two top views of a coaster demonstrating a hidden message that is activated by liquid in accordance with some embodiments. Top view 300 illustrates an example design for coaster 100 when dry. In the example, a company logo is displayed, which may be printed in thermal transfer ink on cover layer 102. Color-changing ink applied to liquid absorption layer 104 overlaps and obscures a hidden message printed in UV cured ink.

Top view 302 illustrates the liquid-activated message, which is exposed when the color-changing ink becomes wet. As liquid is absorbed, cover layer 102 becomes transparent, and the color-changing ink becomes clear. As a result, the hidden message, “Patent Pending”, appears below the company logo. The color of the logo and message may be the same or different depending on the color of ink applied.

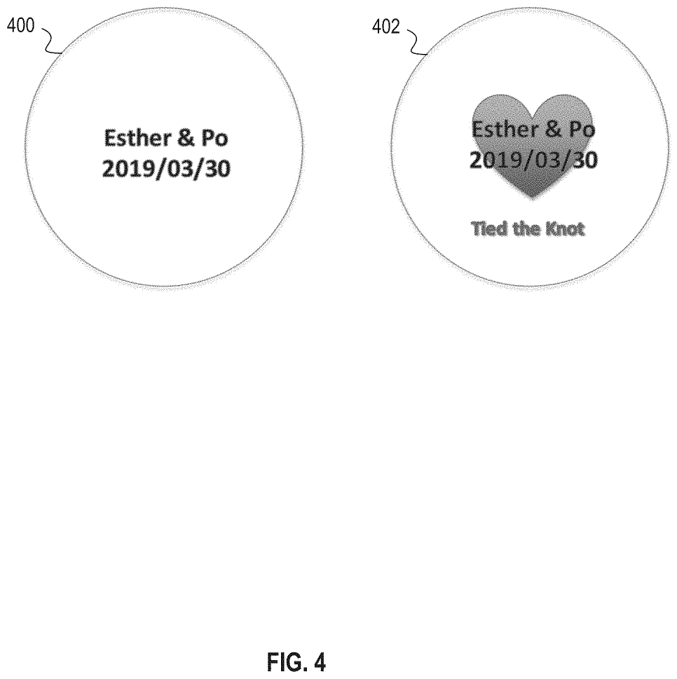

FIG. 4 illustrates two top views of a coaster demonstrating a hidden message and artwork that is activated by liquid in accordance with some embodiments. Top view 400 illustrates a name and date that are visible when coaster 100 is dry. Top view 402 illustrates an image of a heart that appears behind the name and date when the color-changing ink is wet. The image further includes the text “Tied the Knot” below the heart, name, and date.

In some embodiments, the liquid-activated image and text shown in top view 402 are provided by an online service. Users may then submit a name and date to print on cover layer 102 to customize the coaster. The coasters may be pre-assembled and customized at the final step for a variety of wedding venues. Similarly, designs may be customized for other events and organization. Additionally or alternatively, the online service may allow users to select and/or provide other images to customize the graphics on cover layer 102 and/or liquid absorption layer 106.

5. Miscellaneous; Extensions

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A multi-layer coaster comprising:
a first layer including bonded fibers;
a second layer including absorptive material, wherein the bonded fibers included in the first layer protect the absorptive material from solid objects placed on the multi-layer coaster; and
an adhesive that bonds the first layer to the second layer around a perimeter, wherein a portion of the first layer and the second layer are not bonded to prevent the adhesive from obstructing liquid passing from the bonded fibers of the first layer to the absorptive material included in the second layer.

2. The multi-layer coaster of claim 1, wherein the bonded fibers of the first layer include hydroentangled polyester and paper fibers.

3. The multi-layer coaster of claim 2, wherein the bonded fibers are approximately half polyester fibers and half paper fibers.

4. The multi-layer coaster of claim 1, wherein the absorptive material of the second layer includes water-soluble paper.

5. The multi-layer coaster of claim 1, wherein the adhesive that bonds the first layer to the second layer includes double sided tape around the perimeter.

6. The multi-layer coaster of claim 1, further comprising a third layer that includes insulating material; wherein the second layer is bonded to the first layer and the third layer; wherein the first layer is above the second layer and the second layer is above the third layer when the multi-layer coaster rests on a surface.

7. The multi-layer coaster of claim 6, further comprising a removable liner; wherein the third layer includes downward facing acrylic adhesive to prevent slipping on surfaces where the multi-layer coaster is placed after the liner is removed.

8. The multi-layer coaster of claim 1, wherein at least one of the first layer or the second layer includes a design; wherein a visibility of the design increases when at least one of the first layer or the second layer is wet.

9. A coaster comprising one or more layers, wherein the one or more layers include at least a first part of a design printed in color-changing ink and at least a second part of the design printed in a different type of ink, wherein the color-changing ink at least partially overlaps the different type of ink and changes colors when wet.

10. The coaster of claim 9, wherein the color-changing ink is applied to a first layer of the coaster and the different type of ink is applied to a second layer of the coaster.

11. The coaster of claim 9, wherein the type of ink includes ultraviolet curing ink with a threshold amount of ultraviolet exposure.

12. The coaster of claim 9, wherein the color-changing ink includes hydrochromic ink that becomes clear when wet.

13. The coaster of claim 9, wherein the design includes a message that increases in visibility when wet.

14. The coaster of claim 9, wherein the first part of the design and the second part of the design are printed on a same layer of the coaster.

15. The coaster of claim 9, wherein the first part of the design is printed on a first layer of the coaster and the second part of the design is printed on a second layer of the coaster, wherein the second part of the design increases in visibility when at least one of the first layer or the second layer is wet.

16. The coaster of claim 9, wherein the color-changing ink is hydrochromic ink that at least partially obscures the first part of the design when dry; wherein the second part of the design is printed in thermal transfer ink that is visible when dry or wet.

17. A method comprising:
identifying a first image to print and a second image to print on one or more layers of a coaster;
applying a first type of ink to print the first image on at least a first layer of the one or more layers of the coaster;
applying a second type of ink to print the second image on at least one of the first layer or a second layer of the one or more layers of the coaster;
wherein the first type of ink is different than the second type of ink.

18. The method of claim 17, wherein the first type of ink is color-changing ink and the second type of ink is ultraviolet curing ink.

19. The method of claim 18, further comprising applying a third type of ink to at least one of the one or more layers of the coaster, wherein the third type of ink is thermal transfer ink.

20. The method of claim 18, wherein the color-changing ink becomes clear when wet to reveal the second image printed in the ultraviolet curing ink.
